(19) United States
(12) Patent Application Publication
(10) Pub. No.: US 2004/0091845 A1
(43) Pub. Date: May 13, 2004

(54) System and method for virtual reality training for odontology

(76) Inventors: Jean Azerad, Bagneux (FR); Julien Blanchard, Paris (FR); Yves Maurin, Paris (FR)

Correspondence Address: YOUNG & THOMPSON, 745 SOUTH 23RD STREET 2ND FLOOR, ARLINGTON, VA, 22202

(21) Appl. No.: 10/258,732

(22) PCT Filed: Apr. 25, 2001
(86) PCT No.: PCT/FR01/01271

(30) Foreign Application Priority Data
Apr. 26, 2000 (FR) 00/05298

(51) Int. Cl. G09B 23/28

(52) U.S. Cl. 434/263; 434/307 R; 434/365

(57) ABSTRACT

A system for virtual reality training, to acquire procedure movements in odontology, by sensing data concerning spatial position of a real hand-held element (2), three-dimensional representation of a virtual object (T) on a display screen (7), processing spatial position data for providing spatial display of a virtual instrument (OV) corresponding to the actual spatial position of the real element (2), supplying a virtual instrument (01-04) for operating on the virtual object (T) and modelling an interaction between the virtual instrument and said virtual object (T). The hand-held element (2) belongs to a haptic man-machine interface (IHM) comprising actuators controlled to supply the user holding in his hand the real element (2) with a force-feedback when the virtual instrument (OV) interacts with the virtual object (T). The invention is useful for pedagogical and professional purposes.

The present invention relates to a virtual reality training system for dentistry. It also relates to a learning method implemented in this system, as well as its use for training and for modelling therapeutic strategies.

In the context of the education of students in dental surgery, training in the basic operating techniques is generally carried out on natural teeth removed post mortem. These are rare and expensive, and difficult to obtain, constituting a heavy burden on the budgets of universities and training centres. Moreover, the frequently unknown origin of these teeth exposes their users to unacceptable contamination risks. Artificial teeth are commercially available, but the cheapest are made of a homogenous material which does not reproduce the structure of the tooth (enamel, dentin, pulp), whereas heterogeneous artificial teeth, which are more realistic, are difficult to access as they exceed training budgets.

More generally, any learning of mechanical treatment techniques for therapeutic or industrial purposes involving irreversible actions on solid objects, such as piercing, drilling, scraping or engraving can be affected by the problem of obtaining objects for treatment.

The company Denx Ltd markets a virtual reality dental workstation called DentSim, comprising a patient simulator equipped with sensors connected to a computer, a complete set of dental surgery instruments and software tools providing the user with a three-dimensional view of the patient simulator's jaws. U.S. Pat. No. 5,688,118 held by the company Denx Ltd thus discloses an image, sound and feeling simulation system for dentistry comprising a portable drill containing a three-dimensional sensor intended to provide the system with the spatial position and orientation of the drill, and a data processing and display unit. The user of this simulation system operates on artificial teeth housed in artificial jaws of a dummy simulating a patient. This system further comprises means for controlling the compressed air flow supplied to the drill and thus controlling its rotation speed in order to imitate the sound and feeling corresponding to a drilling operation through layers of the tooth having different degrees of hardness.

While such a system can indeed provide training means for education in dentistry, it nevertheless has a complex structure involving in particular the installation of a compressed air supply, which necessarily entails a high cost, which does not necessarily make it accessible to all dentistry training centres.

A main objective of the invention is to remedy this problem by offering a virtual reality training system allowing students or practitioners who are undergoing initial or ongoing training to learn the correct procedures and practices, and which is furthermore of significantly lower cost than a conventional dental workstation comprising inter alia the necessary rotary instruments.

Moreover, beyond training requirements, there are also needs, in particular in dental surgeries, in terms of therapeutic and intervention strategy modelling, for example in orthodontics, where treatments are simulated on typodonts, and the artificial teeth subjected to orthodontic forces are embedded in a wax support which must be softened by warming.

Another purpose of the present invention is therefore to propose a virtual reality software application which provides practitioners with a modelling tool for defining an intervention strategy.

These objectives are reached with a virtual reality training system for the acquisition of operating procedures in dentistry, comprising:

a real accessory which can be hand-held,

means for providing position and orientation information on said real accessory,

computer-based means for providing a three-dimensional representation of a virtual object on a screen, in particular a virtual tooth or set of virtual teeth, and a spatial display of a virtual handtool corresponding to the effective spatial position of said real accessory, and

a haptic man-machine interface device including the real accessory which can be hand-held and comprising actuators controlled by said computer-based means in order to provide a user holding said real accessory in his hand with a force feedback when the virtual handtool interacts with the virtual object.

According to the invention, the modelling means comprise means for modelling a heterogeneous structure of the virtual object and for supplying the control means with force feedback information depending on said heterogeneous structure and functional characteristics of the virtual handtool.

It is thus possible to have available a training system which only requires as its hardware infrastructure a computer or IT workstation and a haptic man-machine interface device of the type of those currently available. Unlike the training system disclosed in the aforementioned document U.S. Pat. No. 5,688,118, it is not necessary to provide a real physical interaction between a genuine drill and an artificial tooth. In the present invention, the only real mechanical operation to be provided resides in the production of a force feedback to the real training accessory held by the user, which considerably reduces the cost of implementing this method as a result of the current availability of haptic man-machine interfaces.

In a particular embodiment of a system according to the invention, the man-machine interface device further comprises an articulated mechanical structure designed to receive the real accessory at one of its ends.

The system according to the invention can furthermore advantageously comprise means for modelling an interaction between the virtual handtool and the virtual object.

The haptic interface device can furthermore co-operate with the computer in order to provide the user with a function allowing selection of a virtual handtool from a set of available virtual handtools. These tools can include a handtool comprising a part which rotates at an adjustable speed.

A virtual handtool can be manufactured using virtual handtools proposed. Moreover, certain actions on the model by virtual handtools can be cancelled.

Means can also be provided within a system according to the invention for playing predetermined sounds in response to predetermined interactions between the virtual handtool and the virtual object, as well as means for modelling thermal effects within the virtual object during interaction with the virtual handtool.

The real accessory can be a probe, which has physical and dimensional characteristics which are similar to those of a real handtool. This probe can also be constituted by a real handtool fixed in a removable manner to the end of the articulated mechanical structure.

It should be noted that a heterogeneous haptic structure can be provided for a single virtual accessory (or model).

The haptic properties of this virtual accessory can be modified by the intrinsic properties of the virtual handtool (speed of rotation of the handtool, duration of the contact between the accessory and the handtool).

The user can generate a new heterogeneous model by assigning a haptic property to a region modified (virtual removal of material from an initial model) by a virtual handtool.

Provision can be made in the context of the present invention for working on the model in indirect vision via the modelling of a virtual mirror (reversal of direction between the user's movements and those of the displayed virtual handtool).

According to another aspect of the invention, a virtual reality training method is proposed for the acquisition of operating procedures in dentistry, implemented in the system according to the invention, comprising:

capture of spatial position data for a real hand-held accessory,

a three-dimensional representation of a virtual object, in particular a virtual tooth, on a screen,

the provision of a virtual handtool capable of operating on the virtual object and a modelling of an interaction between said virtual handtool and said virtual object,

a processing of spatial position information in order to provide a spatial display of the virtual handtool corresponding with the effective spatial position of said real accessory, said real hand-held accessory belonging to a haptic man-machine interface device comprising actuators controlled in order to provide a user holding said real accessory in his hand with a force feedback when the virtual handtool interacts with the virtual object.

The training method according to the invention is characterized in that it implements a software interface between, on the one hand, spatial position capture functions and force feedback actuator control functions within the haptic interface device and, on the other hand, modelling and three-dimensional representation functions for virtual objects and handtools carried out within the computer.

The method according to the invention can furthermore advantageously comprise modelling of a heterogeneous structure of the virtual object and generation of force feedback data depending on said heterogeneous structure and on functional characteristics of the virtual handtool.

The training method according to the invention can advantageously include the possibility of providing numerical data on the work carried out by the user (volume of virtual material removed, added; duration of work, passing of the handtool through certain anatomical beacons within the heterogeneous structure).

Moreover, the transparency of one of the heterogeneous parts of the model can be modified in order to display the internal structure of the accessory.

It can also be arranged to generate an image representing and X-ray or radiography of the virtual model selected by the user.

Furthermore, the training method according to the invention can advantageously include the display of a video sequence of the work carried out by the user (playback).

The virtual reality training system and method according to the invention are directly applied in the field of dentistry where virtual objects are teeth and virtual handtools are surgical handtools. These virtual teeth can be inserted into a virtual jaw which can itself form an integral part of a virtual head.

This use can equally relate to training in dentistry or the modelling of therapeutic strategies.

Other features and advantages of the invention will become further apparent in the following description. In the appended drawings, provided as non-limitative examples:

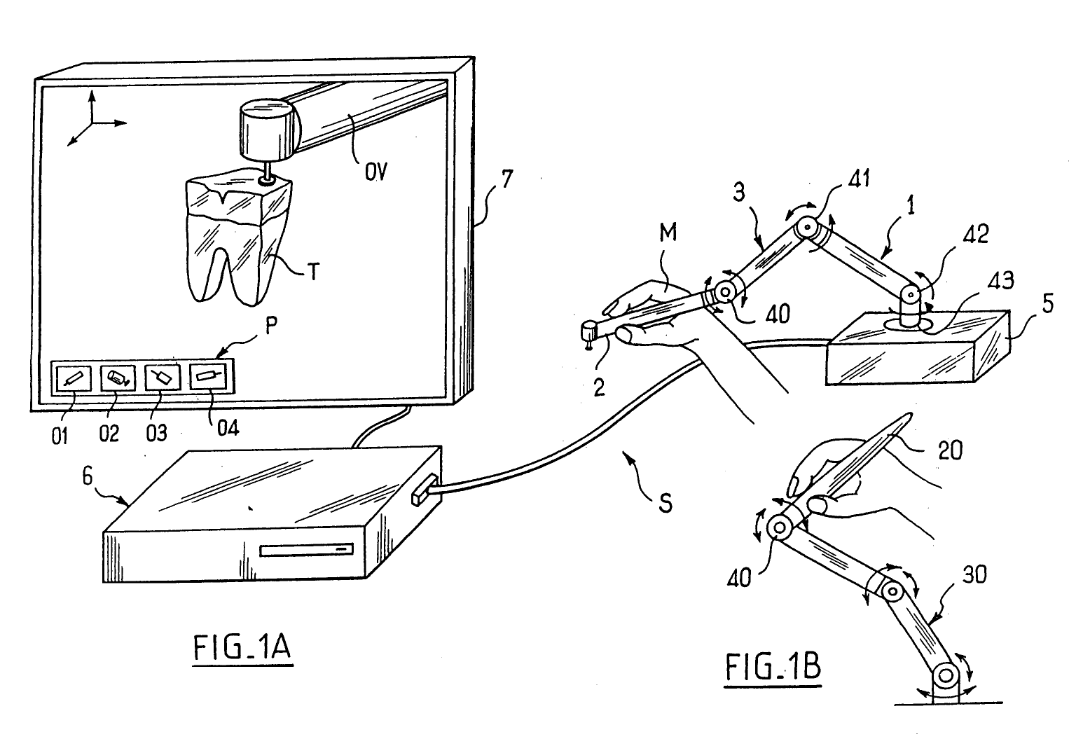

FIG. 1A is a block diagram of a virtual reality training system according to the invention, in which the real accessory is a drill;

FIG. 1B illustrates a specific implementation in which the real accessory is a probe;

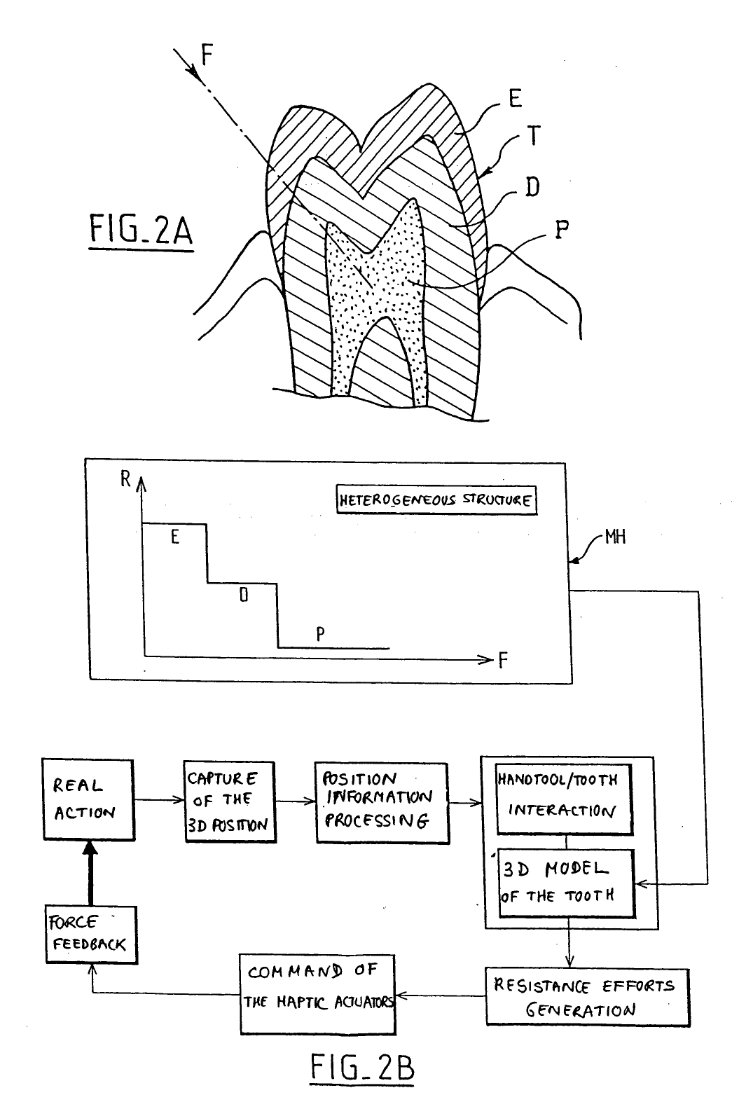

FIG. 2A is a simplified section view of a tooth treated by the method according to the invention;

FIG. 2B is a functional diagram of the generation of a force feedback in a haptic virtual reality method according to the invention; and

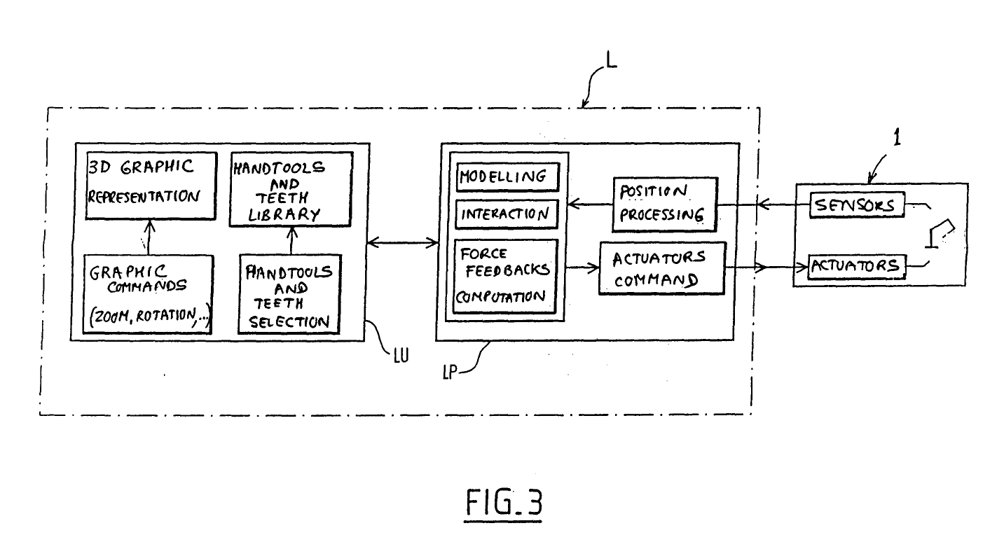

FIG. 3 is a block diagram of a software program implementing the haptic virtual reality method according to the invention.

There follows a description, with reference to FIG. 1A, of the general structure of a virtual reality training system according to the invention. This system S comprises a haptic interface device 1 comprising an articulated arm 3 having at its free end a real accessory 2, for example a drill or a dummy or copy of a drill, which can be held in a user's hand M, and a computer 6 to which this haptic interface device is connected.

The virtual reality training method according to the invention can advantageously but not limitatively implement the PHANTOM™/DESKTOP® haptic system produced and marketed by the company SensAble Technologies Inc, which includes a complete haptic interface device with force feedback.

The articulated arm 3 comprises for example three articulations 40, 41, 42 and a rotary link 43 to a base 3 containing electronic power supply and control circuits. Each articulation is equipped with an angular position sensor and an electric actuator, for example a piezoelectric actuator or any other electromechanical conversion technology able to provide a force feedback.

The computer 6 is equipped with a screen 7 allowing a three-dimensional representation to be displayed of a virtual tooth T and a virtual handtool OV in action on said virtual tooth, as well as a palette P of virtual handtools 01-04 which can be accessed by the user of the system.

It should be noted that provision can also be made for the articulated arm 30 to be equipped at its end with a simple probe 20 which the user can hold in his hand, with reference to FIG. 1B.

There follows a description, with reference to FIGS. 2A and 2B, of the treatment of the heterogeneous structure of a tooth implemented in the haptic virtual reality method according to the invention.

A virtual tooth T is considered the heterogeneous structure of which was previously modelled spatially taking into account the different internal zones within a tooth: enamel E, dentin D and pulp P. When a drilling action is carried out from the apex of the virtual tooth T, the three zones E, D and F are crossed successively. A model MH of the heterogeneous structure is developed in order to associate a specific level of mechanical resistance R with each zone.

When a real action displacing the probe handtool 2 is carried out by the user, the sensors of the haptic interface device 1 supply spatial position data for the probe handtool which is processed in order to determine the level of interaction between the virtual handtool OV and the virtual tooth T and in order to obtain three-dimensional modelling of the tooth operated on which takes the heterogeneous model MH into account. From this modelling, information can be generated on the efforts due to the variable resistance of the different zones in the virtual tooth, and this information is translated into commands for actuators in the haptic interface device which finally provides the user with a force feedback.

The software program L developed for the implementation of the haptic virtual reality method according to the invention in the particular context of dentistry comprises, for example with reference to FIG. 3, a driver program LP for the haptic interface device 1 having all the basic features required for use in the field of dentistry, and a user interface program LU suitable for the marketing sector of the virtual reality system according to the invention.

The driver program LP handles the processing of the position data received from the sensors, the control of the force feedback actuators, the three-dimensional modelling of a virtual tooth, virtual handtools and the tooth/handtool interaction, and the calculation of force feedbacks.

The user interface program LU handles the three-dimensional graphical representation of the teeth and virtual handtools, the management of a virtual tooth and handtool library, the control of graphical commands such as zoom, translation, rotation, etc., and the selection of virtual handtools from a palette of available handtools.

The probe handtool 2 can be of a general purpose type or can be removable and have the dimensional and physical characteristics (weight, material and external surface) of a dental surgery handtool.

The driver program allows the display and manipulation of three-dimensional objects with a realistic rendition, and their modification by virtual handtools. The resistance of the material constituting virtual objects is taken into account by a force feedback to the articulated arm: the more resistant the virtual object is, the harder this is to manipulate.

A computer must be chosen which is powerful enough to fluidly implement realistic three-dimensional objects. As a non-limitative example, a two-processor machine of PC type can be used, one processor being dedicated to the display function while the other is dedicated to the calculation function.

The use of the haptic virtual reality system and method according to the invention for dentistry involves the modelling of a set of tooth types treated and a range of basic handtools used in dental surgery. These are in particular fixed- or variable-speed drills and turbines with different drill bit models, as well as hooks, moulds, brackets and orthodontic arches.

The main functions provided by the virtual reality training system according to the invention may include:

taking into account of an adjustable scale factor of the virtual representation with respect to the real world,

mechanical action functions on a virtual tooth, in particular drilling, scraping, adding material (fillings in amalgam or composite resins) and pressing a form in a mould,

a representation of the heterogeneous structure of the tooth with variations in resistance,

a homothetic transformation in the relative virtual representation of the tooth and the handtool, whatever the level of zoom,

a correlation between the rotation speed of the handtool and the reduction in resistance, for each component of the tooth: enamel, dentin, pulp.

Optionally, provision can also be made for the following functions:

the possibility of increasing the opening of the jaw,

a vibratory force feedback (buzz) on the user's arm, simulating the use of a drill,

the hardening over time of a material added to a virtual tooth,

the possibility of composing a custom model by selecting teeth to be inserted into a jaw.

In the context of the present invention, a library of virtual teeth can be set up in order to cover the range of teeth encountered in the practice of dentistry. These virtual teeth can be displayed individually, or inserted into a virtual jaw which can itself be inserted into a virtual face.

Naturally, the invention is not limited to the examples which have just been described and numerous modifications can be made to these examples without exceeding the scope of the invention. Other haptic interface device structures than those which have just been described can thus be envisaged. Moreover, provision can be made for a haptic interface device to be connected to a remote computer via one or more communications networks, in particular via the Internet.

Provision can also be made in the training system according to the invention for means for playing predetermined sounds in response to predetermined interactions between the virtual handtool and the virtual object. These sounds can include a simulation of the noise made by real tools, which can vary in particular according to the rotation speed of the handtool and the physiological layer being crossed, or also the simulation of a patient's reaction to the operating procedure being carried out. Furthermore, this system can also comprise means for modelling thermal effects within the virtual object during interactions with the virtual handtool.

1. Virtual reality training system (S) for the acquisition of operating procedures in dentistry, comprising:
a real accessory (2, 20) which can be hand-held,
means for providing position and orientation information on said real accessory,
computer-based means (6) for providing a three-dimensional representation of a virtual object (T) on a screen (7), in particular a virtual tooth or set of virtual teeth, and a spatial display of a virtual handtool corresponding to the effective spatial position of said real accessory (2),
a haptic man-machine interface (IHM) device (1) including the real accessory (2) which can be hand-held and comprising actuators controlled by said computer-based means (6) in order to provide a user holding said real accessory (2) in his hand with a force feedback when the virtual handtool (OV) interacts with the virtual object (T),
characterized in that the modelling means comprise means for modelling a heterogeneous structure of the virtual object (T) and for supplying the control means with force feedback information depending on said heterogeneous structure and functional characteristics of the virtual handtool (OV).

2. System (S) according to claim 1, characterized in that the man-machine interface device (1) further comprises an articulated mechanical structure (3) designed to receive the real accessory (2) at one of its ends.

3. System (S) according to any one of claims 1 or 2, characterized in that it further comprises software means for providing means for modelling an interaction between said virtual handtool (OV) and said virtual object (T).

4. System (S) according to any one of claims 1 to 3, characterized in that the haptic interface device (1) cooperates with the computer-based means (6) to provide the user with a function allowing selection of a virtual handtool (OV) from a set of available virtual handtools (01-04).

5. System (S) according to any one of claims 1 to 4, characterized in that the virtual handtools comprise a handtool (OV) comprising a part which rotates at an adjustable speed.

6. System (S) according to any one of claims 1 to 5, characterized in that the modelling means further comprise means for modelling a set of virtual objects.

7. System (S) according to one of claims 1 to 6, characterized in that the real accessory is a probe (20).

8. System (S) according to claim 7, characterized in that the probe has similar dimensional and physical characteristics to those of a real handtool.

9. System (S) according to claim 8, characterized in that the probe is constituted by a real handtool (2) fixed in a removable manner to the end of the articulated mechanical structure (3).

10. System (S) according to one of claims 1 to 9, characterized in that it further comprises means for playing predetermined sounds in response to predetermined interactions between the virtual handtool (OV) and the virtual object (T).

11. System (S) according to one of claims 1 to 10, characterized in that it further comprises means for modelling thermal effects within the virtual object (T) during interactions with the virtual handtool (OV).

12. System according to any one of the previous claims, characterized in that it further comprises a heterogeneous haptic structure of the same virtual accessory (or model).

13. Virtual reality training method for the acquisition of operating procedures in dentistry, implemented in the system according to any one of the previous claims, comprising:
capture of spatial position data for a real hand-held accessory (2, 20),
a three-dimensional representation of a virtual object (T) on a screen (7),
the provision of a virtual handtool (OV) capable of operating on the virtual object (T) and a modelling of an interaction between said virtual handtool (OV) and said virtual object (T),
a processing of spatial position information in order to provide a spatial display of the virtual handtool corresponding with the effective spatial position of said real accessory (2),
said real hand-held accessory (2, 20) belonging to a haptic man-machine interface (IHM) device (1) comprising actuators controlled in order to provide a user holding said real accessory (2) in his hand with a force feedback when the virtual handtool (OV) interacts with the virtual object (T),
characterized in that it implements a software interface between, on the one hand, spatial position capture functions and force feedback actuator control functions within the haptic interface device and, on the other hand, modelling and three-dimensional representation functions for virtual objects and handtools carried out within the computer.

14. Method according to claim 13, characterized in that it further comprises modelling of a heterogeneous structure of the virtual object (T) and generation of force feedback data depending on said heterogeneous structure and functional characteristics of the virtual handtool (OV).

15. Method according to one of claims 13 or 14, characterized in that it further comprises a modification of the haptic properties of the virtual accessory by the intrinsic properties of the virtual handtool.

16. Method according to one of claims 13 to 15, characterized in that it further comprises the generation of a new heterogeneous model by assigning a haptic property to a region modified by a virtual handtool.

17. Method according to one of claims 13 to 16, characterized in that it further comprises modelling of a virtual mirror.

18. Method according to claim 17, characterized in that the modelling of a virtual mirror comprises a reversal of direction between the user's movements and those of the displayed virtual handtool.

19. Method according to one of claims 13 to 18, characterized in that it further comprises the supply of quantitative information on the work carried out by the user.

20. Method according to claim 19, characterized in that the quantitative information provided comprises information on the volume of virtual material removed or added.

21. Method according to one of claims 19 or 20, characterized in that the quantitative information provided comprises information on the duration of the work carried out by the user.

22. Method according to one of claims 19 to 21, characterized in that the quantitative information provided comprises information on the passing of the handtool through certain anatomical beacons within the heterogeneous structure.

23. Method according to one of claims 13 to 22, characterized in that it further comprises modification of the transparency of one of the heterogeneous parts of the model can be modified in order to display the internal structure of the accessory.

24. Method according to one of claims 13 to 23, characterized in that it further comprises generation of an image representing a radiography of the virtual model selected by the user.

25. Method according to one of claims 13 to 24, characterized in that it further comprises the display of a video sequence of the work carried out by the user.

26. Use of the system and method according to any one of the previous claims, in which the virtual objects are teeth and the virtual handtools are surgical handtools.

27. Use according to claim 26, in which virtual teeth can be inserted into a virtual jaw.

28. Use according to claim 27, in which the virtual jaw is inserted into a virtual head.

29. Use of the system according to any one of the previous claims for training in dentistry.

30. Use of the system and method according to any one of the previous claims for the modelling of therapeutic strategies.
